(19) United States
(12) Patent Application Publication
(10) Pub. No.: US 2010/0252209 A1
(43) Pub. Date: Oct. 7, 2010

(54) SAFETY STRUCTURE OF ROMAN SHADE

(76) Inventor: Teng-Hao WANG, Kaohsiung City (TW)

Correspondence Address: LEONG C LEI, PMB # 1008, 1867 YGNACIO VALLEY ROAD, WALNUT CREEK, CA, 94598, US

(21) Appl. No.: 12/418,618

(22) Filed: Apr. 6, 2009

(51) Int. Cl. E06B 9/24

(52) U.S. Cl. 160/84.04

(57) ABSTRACT

A safety structure is provided for a Roman shade. A shade cloth is constituted by first and second sheet members opposing each other. The first sheet member forms folds, each carrying at least one cord ring through which a lift cord that functions to roll the shade cloth up and down extends. The cord rings of the first sheet member are arranged between the first and second sheet members, so as to have the lift cord that extends through the cord rings concealed between the first and second sheet members. As such, operation safety of the Roman shade is enhanced.

### TECHNICAL FIELD OF THE INVENTION

The present invention generally relates to a safety structure of a Roman shade, and particularly to a safety Roman shade with enhanced safety of use.

### DESCRIPTION OF THE PRIOR ART

As shown in FIG. 1 of the attached drawings, a conventional Roman shade comprises a shade cloth 11, a head rail 12, a cord lock 13, and lift cords 14.

The shade cloth 11 is provided with a plurality of folds 111 and each fold 111 forms a plurality of loops 112 each carrying a cord ring 113 through which the lift cord 14 extends. A bottom rail 114, which is of a substantial weight, is arranged below and attached to the shade cloth 11.

The head rail 12 is set above the shade cloth 11 and the head rail 12 supports the cord lock 13 that functions to selectively fix the lift cords 14. To allow the shade cloth 11 to be evenly rolled up and down, two lift cords 14 are often provided.

Each lift cord 14 has an upper end extending in and along the head rail 12 and projecting out of the head rail 12 through the cord lock 13, and a lower end extending downward through the cord rings 113 that are carried by the loops 112 of the shade cloth 11 and fixed to the bottom rails 114 set at a bottom of the shade cloth 11.

The cord lock 13 is mounted to an end of the head rail 12 for fixing the lift cords 14 after the lift cords 14 roll up the shade cloth 11, thereby fixing the shade cloth 11 in position.

The operation of the conventional Roman shade 1 is done by pulling the lift cords 14 to roll the shade cloth 11 up or down for shading or not shading from sun light.

The conventional Roman shade 1 that has the above structure is effective in shading or not shading sun light. However, safety problems exist for the conventional Roman shade 1. As shown in FIG. 2, since the lift cords 14 are set through the cord rings 113 carried by the loops 112 of the shade cloth 11 and the cord rings 113 are securely attached to the loops 112 and further since upper and lower ends of the lift cords 14 are respectively fixed to the cord lock 13 and the bottom rail 114 on the bottom side, when a young child plays around where a Roman shade is located, the child can get entangled and thus tripped by the lift cord 14 and once entangling with the child, the lift cord 14 is pulled and stretches out, eventually forming a loop A which may get around the neck of the child. Since the cord ring 113 is rigid, the cord ring 113 may function as a support point B for the portion of the lift cord 14 below the loop A. This makes the loop A a lethal risk to the child. Thus, it is an important issue to be though over and overcome by the Roman shade industry as to how to eliminate the use safety concern of the conventional structure of Roman shade 1.

### SUMMARY OF THE INVENTION

In view of the above discussed problem, the primary objective of the present invention is to provide a safety structure for a Roman shade. The Roman shade comprises a shade cloth, a head rail, a cord lock, a lift cord, and a bottom rail. The shade cloth comprises first and second sheet members and the first sheet member forms a plurality of folds, each carrying a plurality of cord rings. The head rail is arranged above the shade cloth and supports the cord lock. The cord lock serves to selectively fix the lift cord. The lift cord has an upper end extending through the head rail and further extending through the cord lock to project out of the head rail and a lower end extending downward through the cord rings of the shade cloth whereby the lift cord can be withdrawn to roll the shade cloth up and down. The cord rings of the first sheet member are arranged between the first and second sheet members, so as to have the lift cord concealed between the first and second sheet members. As such, safety of operation of the Roman shade is enhanced.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional Roman shade.

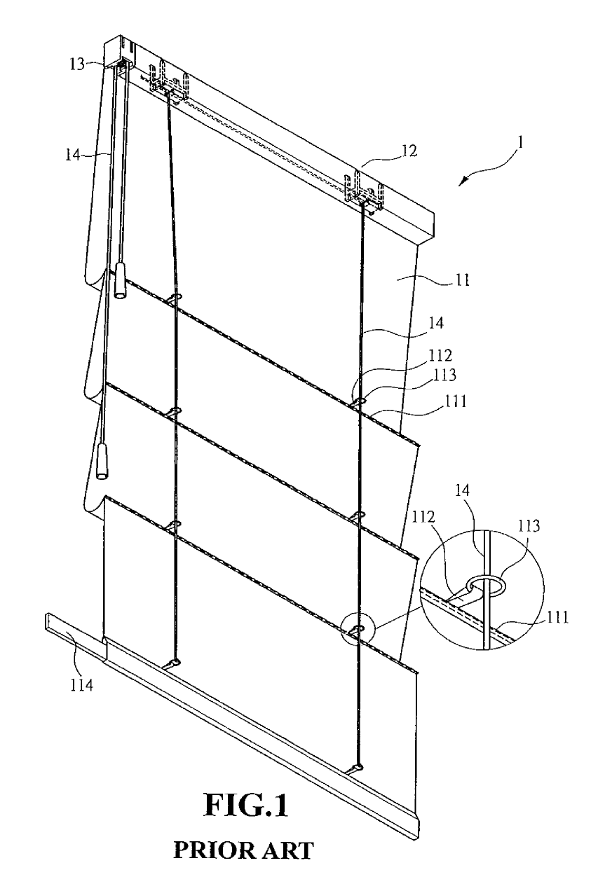

FIG. 2 is a perspective view illustrating the risk of use of the conventional Roman shade.

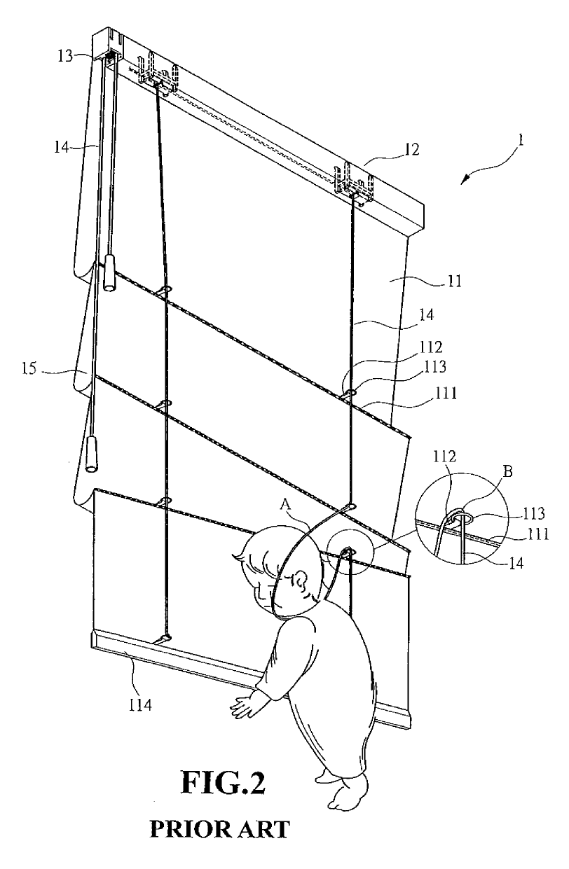

FIG. 3 is an exploded view of a Roman shade constructed in accordance with the present invention.

FIG. 4 is a perspective view of the Roman shade of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

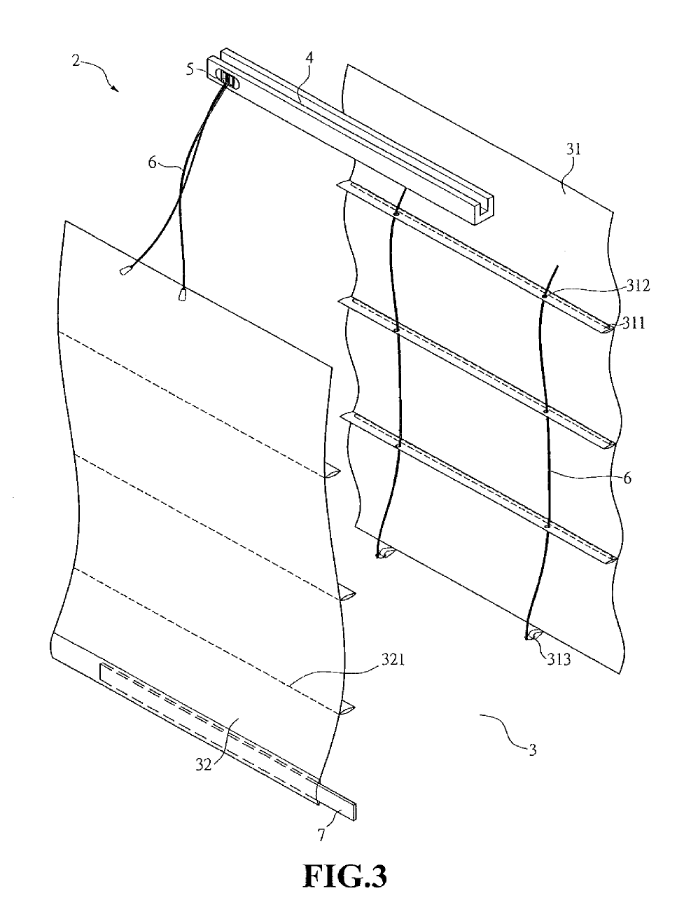

The present invention provides a safety structure of Roman shade, which is particularly illustrated in FIG. 3. The Roman shade in accordance with the present invention, generally designated at 2, comprises a shade cloth 3, a head rail 4, a cord lock 5, lift cords 6, and a bottom rail 7.

The shade cloth 3 is constituted by a first sheet member 31 and a second sheet member 32. The first sheet member 31 forms a plurality of folds 311 and each fold 311 is provided with a passage means for the lift cord 6. The passage means may be a cord ring 312 or a hole formed in the fold 331. The hole may be circular or any other shape as desired. Fastening lugs 313 are provided on a bottom of the first sheet member 31 and arranged to correspond to the cord rings 312. The second sheet member 32 forms a plurality of folds 321 corresponding to the first sheet member 31 and the folds 321 are attachable to the folds 311 of the first sheet member 31 by for example sewing or other known means. A bottom rail 7, which is of a substantial weight, is set on a bottom of the second sheet member 32. With such a bottom rail 7, the first and second sheet members 31, 32 are maintained in a well-depending condition.

The head rail 4 is set above the shade cloth 3 and the head rail 4 supports the cord lock 5 that functions to withdraw and fix the lift cords 6. To allow the shade cloth 3 to be evenly rolled up and down, two lift cords 6 are often provided.

Each lift cord 6 has an upper end extending in and along the head rail 4 and projecting out of the head rail 4 through the cord lock 5, and a lower end extending downward through the cord rings 312 of the shade cloth 3 and is further fixed to the corresponding fastening lug 313 on the bottom of the first sheet member 31. The fastening lugs 313 are on the bottom rail 7.

The cord lock 5 serves to fix and withdraw the lift cords 6 so as to operate the lift cords 6 to roll the shade cloth 3 up and down.

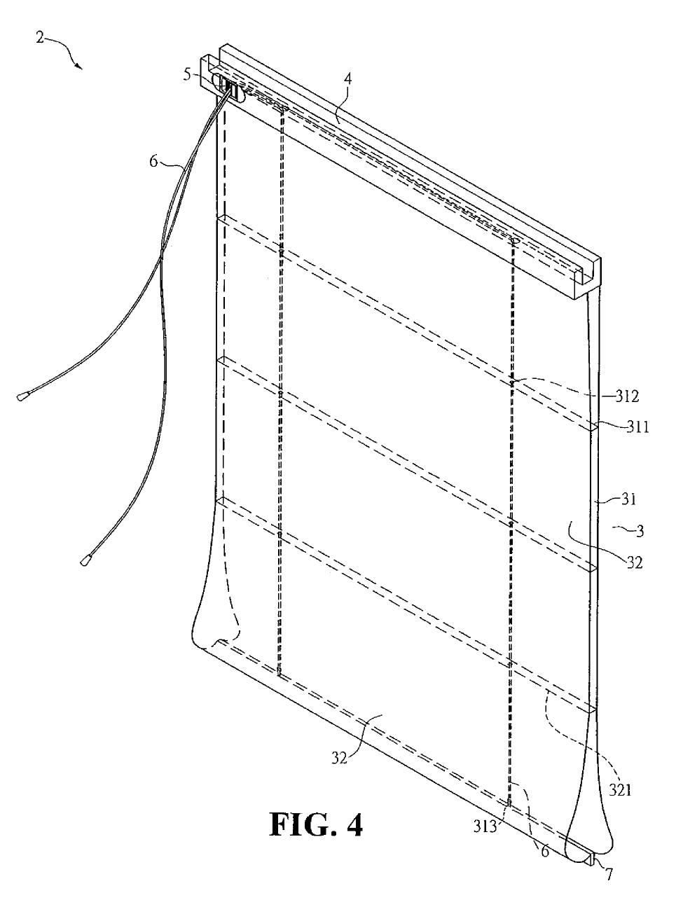

Also referring to FIG. 4, to practice the present invention, the folds 311 of the first sheet member 31 are fixed to the corresponding folds 321 of the second sheet member 32 by means of sewing. The lower ends of the lift cords 6 are attached to the fastening lugs 313 of the first sheet member 31 and the upper ends of the lift cords 6 extend upwards through the cord ring 312 of the folds 311 and further extend through openings defined in a bottom of the head rail 4 to the cord lock 5 from which the upper ends of the lift cords 6 project outward. When the lift cords 6 are pulled and/or released to have the first and second sheet members 31, 32 rolled up and/or down from the bottoms thereof, the lift cords 6 are concealed between the first and second sheet members 31, 32.

The present invention features setting the cord rings 312 between the first and second sheet members 31, 23 in order to conceal the lift cords 6 between the first and second sheet members 31, 32, whereby exposure of the lift cords 6 that leads to trapping and trapping of young children can be eliminated and operation safety of the Roman shade is enhanced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A safety structure of Roman shade, wherein the Roman shade comprises a shade cloth, a head rail, a cord lock a lift cord, and a bottom rail;
the shade cloth comprising a first sheet member and a second sheet member, the first sheet member forming a plurality of first folds, each first fold carrying passage means for the lift cord, the second sheet member opposing the first sheet member and attached to the first folds of the first sheet member;
the rail arranged above the shade cloth with the cord lock mounted thereto, the cord lock serving to selectively fix the lift cord;
the lift cord having an upper end extending in and along the head rail and projecting out of the head rail through the cord lock, and a lower end extending downward through the passage means of the lift cord of the shade cloth and fixed to the bottom rail;
whereby when the lift cord is driven, the shade cloth is rolled up and down; and
wherein the passage means of the first sheet member are arranged between the first and second sheet members, so as to have the lift cord concealed between the first and second sheet members.

2. The safety structure according to claim 1, wherein the first sheet member of the shade cloth has a bottom to which fastening lugs are mounted.

3. The safety structure according to claim 1, wherein the passage means is a cord ring.

4. The safety structure according to claim 1, wherein the passage means is a hole.
